(19) United States
(12) Patent Application Publication
(10) Pub. No.: US 2008/0011873 A1
(43) Pub. Date: Jan. 17, 2008

(54) Optimized method of atomizing liquid and a liquid atomizer device for implementing the method

(75) Inventors: Michel Gschwind, Grasse (FR); Fabien Guerrin, Mougins (FR)

Correspondence Address: MATTHEW R. JENKINS, ESQ., 2310 FAR HILLS BUILDING, DAYTON, OH, 45419, US

(73) Assignee: ARECO FINANCES ET TECHNOLOGIE - ARFITEC, Grasse (FR)

(21) Appl. No.: 11/692,347

(22) Filed: Mar. 28, 2007

(30) Foreign Application Priority Data
Mar. 28, 2006 (FR) 0602687

(51) Int. Cl. B05B 17/06

(52) U.S. Cl. 239/102.1; 239/4

(57) ABSTRACT

A method of atomizing is implemented using a liquid atomizer device having an open-topped vessel suitable for containing a liquid for atomizing, and an atomized liquid diffuser arranged in the vessel. The diffuser comprises both a nozzle containing the liquid coming from the vessel and an ultrasound emitter suitable for emitting ultrasound waves into the liquid so as to atomize it. The method includes a stage of atomizing the liquid, which stage is performed until the level of liquid in the vessel is substantially at a predetermined minimum level. The method further comprises a stage of temporarily interrupting the ultrasound emitter during an interruption duration, which stage is performed at the end of the atomizing stage, and during which the liquid contained in the nozzle drops back into the vessel; and then a new atomizing stage that is performed at the end of the interruption duration so long as the level of liquid in the vessel is above the predetermined minimum level.

### BACKGROUND OF THE INVENTION

1. Field of the Invention

The present invention relates to an optimized method of atomizing liquid and to a liquid atomizer device for implementing the method.

2. Description of the Related Art

Atomizing liquid into surroundings, e.g. into a room, can have numerous applications, such as disinfection (atomizing a liquid disinfectant), or humidification (atomizing water) in a hospital ward or an ambulance, diffusing fragrance, or deodorizing a room, etc.

In the state of the art, a method of atomizing a liquid is known that makes use of a liquid atomizer device comprising an open-topped vessel suitable for containing a liquid to be atomized, and an atomized liquid diffuser arranged in the vessel, the diffuser being of the type comprising both a nozzle containing liquid coming from the vessel and an ultrasound emitter suitable for emitting ultrasound waves into the liquid in order to atomize it, the method comprising a stage of atomizing the liquid that is performed until the level of liquid in the vessel becomes substantially at a predetermined stop level.

The atomized liquid is then generally exhausted from the device into the room with the help of a fan arranged in the atomizer device.

It should be observed that the ultrasound emitter vibrates at high frequency so as to generate ultrasound waves, and must therefore be cooled constantly in order to avoid it being damaged by overheating. For this purpose, provision is made for the ultrasound emitter to be continuously immersed in the liquid to be atomized, the liquid serving to cool the ultrasound emitter.

Thus, atomizing of the liquid is usually interrupted before all the liquid covering the ultrasound emitter has been atomized, in order to prevent any vibration of the ultrasound emitter when not immersed in the liquid. Generally, the predetermined minimum level corresponds to the minimum level of liquid needed to ensure that the ultrasound emitter operates without overheating.

The volume of non-atomized liquid that remains in the device after the liquid has been atomized is referred to as the dead volume. This dead volume makes it difficult to clean the device, and sometimes means that the quantity of liquid that is actually atomized is not known accurately, in particular since the dead volume can vary from one device to another.

### SUMMARY OF THE INVENTION

A particular object of the invention is to remedy those drawbacks by providing a method of atomizing liquid that makes it possible to optimize atomization of the liquid, while leaving only a negligible dead volume in the atomizer device.

To this end, the invention provides a method of atomizing liquid with a liquid atomizer device comprising an open-topped vessel suitable for containing a liquid for atomizing, and an atomized liquid diffuser arranged in the vessel, the diffuser being of the type comprising both a nozzle containing liquid coming from the vessel and an ultrasound emitter suitable for emitting ultrasound waves into the liquid so as to atomize it, the method comprising a stage of atomizing the liquid, which stage is continued until the level of liquid in the vessel is substantially at a predetermined stop level, the method being characterized in that it further comprises:

a stage of temporarily interrupting the ultrasound emitter for an interruption duration, which stage is performed after the atomizing stage, and during which the liquid contained in the nozzle drops back into the vessel; and

a new atomizing stage that is performed, providing the level of liquid in the vessel at the end of the interruption duration is above a predetermined minimum level.

Preferably, the predetermined stop level is the predetermined minimum level.

The temporary interruption stage is performed at the end of the atomizing stage, i.e. when the level of liquid in the vessel is substantially at the predetermined minimum level.

During this interruption stage, the liquid contained in the nozzle, i.e. the liquid that was being atomized, is no longer entrained by the vibrations of the ultrasound emitter, and therefore drops back into the vessel, thereby increasing the level of liquid in the vessel.

The level of liquid in the vessel then generally becomes above the predetermined minimum level, so the level of liquid is again sufficient to enable the ultrasound emitter to be allowed to vibrate again without being damaged by overheating. It is then possible to perform a new stage of atomizing the liquid.

The ultrasound emitter is then reactivated, entraining a quantity of liquid into the nozzle in order to be atomized, in a manner that is safe for the ultrasound emitter.

This quantity of liquid that is atomized correspondingly reduces the dead volume. The level of liquid in the vessel then becomes substantially at the predetermined minimum level, and this new atomizing stage is terminated.

It is then possible to proceed with a new stage of temporarily interrupting the ultrasound emitter, and to recycle through stages as described above as often as necessary to ensure that at the end of an interruption stage, the level of liquid in the vessel remains substantially at or below the predetermined minimum level in spite of the fact that the liquid contained in the nozzle has dropped back into the vessel.

Under such circumstances, it can be considered that the quantity of liquid remaining is no longer sufficient to allow the ultrasound emitter to operate without overheating, and it is therefore necessary to move on to a stage of stopping the ultrasound emitter, thereby terminating atomization of the liquid.

It can clearly be seen that the atomization method of the invention enables the dead volume of liquid that remains in the atomizer device to be reduced.

An atomization method of the liquid may further comprise one or more of the following characteristics:

the interruption duration comes to an end when the level of liquid in the vessel becomes above a predetermined minimum level;

the method includes a stage in which the ultrasound emitter is stopped, the stage following the stage of temporarily interrupting the ultrasound emitter if, at the end of the interruption duration, the liquid level in the vessel remains substantially at or below the predetermined minimum level, and/or if the duration of the interruption exceeds a predetermined duration;

the method includes a stage of rinsing the device during which a second liquid is delivered into the appliance, in particular into the vessel, the second liquid being atomized in the same manner as the previously atomized liquid;

the second liquid is a rinsing liquid;

the rinsing liquid is water, the water being atomized until the humidity in the surroundings into which the liquids are atomized reaches a predetermined value; and

the method includes a stage of setting the ultrasound emitter into operation when the level of liquid in the vessel is substantially at a predetermined maximum level.

The invention also provides a liquid atomizer device for implementing an atomizing method as defined above, the device comprising an open-topped vessel suitable for containing a liquid to be atomized, and an atomized liquid diffuser arranged in the vessel, the diffuser being of the type comprising both a nozzle containing the liquid coming from the vessel and an ultrasound emitter suitable for emitting ultrasound waves into the liquid so as to atomize it, the device being characterized in that further comprises: measurement means for measuring the level of liquid in the vessel; and means for interrupting the ultrasound emitter during an interruption duration and for putting the ultrasound emitter back into operation if, at the end of the interruption duration, the level of liquid in the vessel is above the predetermined minimum level.

An atomizer device of the invention may also comprise one or more of the following characteristics:

the device includes means for controlling vibration of the ultrasound emitter to impose vibration on the ultrasound emitter at a predetermined steady frequency while the emitter is in operation;

the device includes means for receiving a first tank of liquid to be atomized for feeding to the vessel, and means for receiving a second tank containing a second liquid to be atomized and arranged upstream from the means for receiving the first tank relative to the vessel;

the nozzle is frustoconical in shape and extends in a longitudinal direction that is inclined relative to a direction that is vertical when the device is in operation so as to encourage filling of the nozzle by the liquid for atomizing and so as to ensure that the ultrasound emitter operates properly;

the means for measuring the level of liquid in the vessel comprise a high level sensor and a low level sensor for sensing the level of the liquid, the low level sensor defining the predetermined minimum level;

the low level sensor is arranged in the vessel in such a manner that the predetermined minimum level is substantially the minimum level of liquid at which the ultrasound emitter can operate without overheating;

the device includes a sensor for sensing the humidity in surroundings into which the liquid is atomized; and

the vessel is shaped to minimize the volume of liquid when the liquid is at the predetermined minimum level.

These and other objects and advantages of the invention will be apparent from the following description, the accompanying drawings and the appended claims.

### BRIEF DESCRIPTION OF THE ACCOMPANYING DRAWINGS

The invention can be better understood on reading the following description given purely by way of example and made with reference to the accompanying drawings, in which:

FIG. 1 is a perspective view of an atomizer device constituting an embodiment of the invention;

FIG. 2 is a section view on arrows II-II of the FIG. 1 atomizer device;

FIG. 3 is a section view on arrows III-III of the FIG. 1 atomizer device;

FIG. 4 is a section view on arrows IV-IV of an atomized liquid diffuser of the FIG. 1 atomizer device; and

FIG. 5 is a diagrammatic view of a circuit for controlling an ultrasound emitter of the FIG. 1 device.

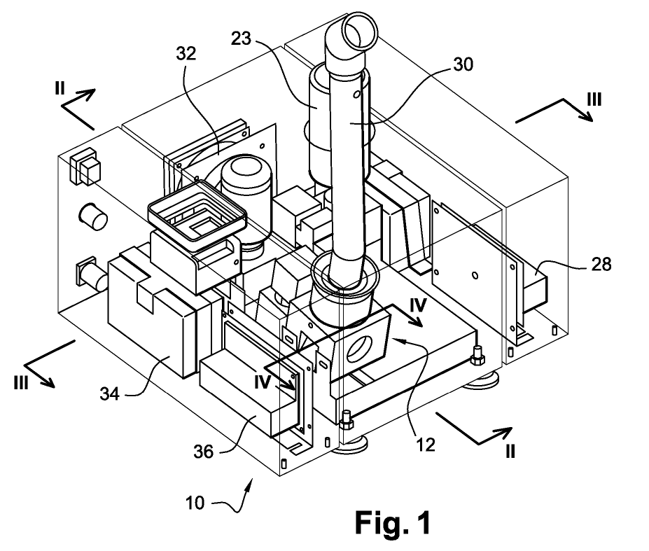

FIGS. 1 to 4 show a liquid atomizer device given overall reference 10 and constituting an embodiment of the invention.

The atomizer device 10 is for diffusing into an environment, a liquid in the form of fine droplets, e.g. a fragrance, a disinfectant, water, etc. For this purpose, the atomizer device 10 is provided with an atomized liquid diffuser 12 provided in a vessel 14 that is open in its top portion and suitable for containing the liquid to be atomized.

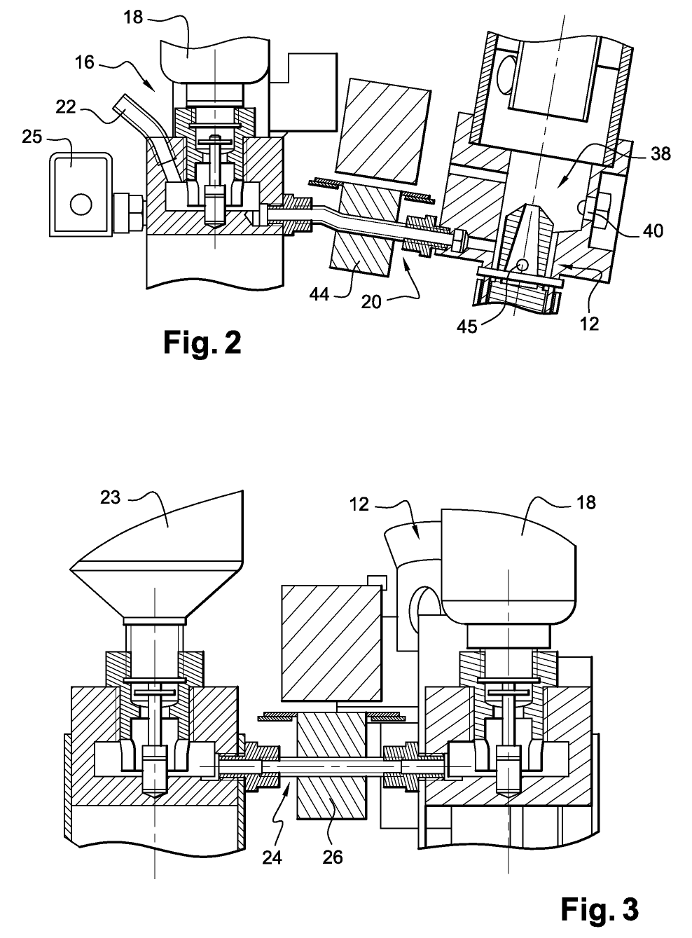

The atomizer device 10 has means 16 (FIG. 2) for receiving a first tank 18 of liquid to be atomized, for feeding the vessel 14 via means 20 for conveying the liquid to the vessel 14.

The means 16 for receiving the tank preferably include an element 22 for connecting the tank 20 to the surrounding air, in order to facilitate emptying the tank 18.

The atomizer device 10 also includes means 16 for receiving a second tank 23 (FIGS. 2 and 3) containing a second liquid to be atomized. In general, the second liquid to be atomized is a rinsing liquid, preferably water.

When the second liquid is water, it can also be used for regulating the humidity of the surroundings into which it is atomized. It is sometimes necessary to regulate the humidity of the surroundings, in particular when the device is used for disinfecting the surroundings, since the effectiveness of a liquid disinfectant depends on the humidity of the surroundings. In order to regulate humidity in this way, the device 10 preferably includes a humidity sensor 25 (FIG. 2).

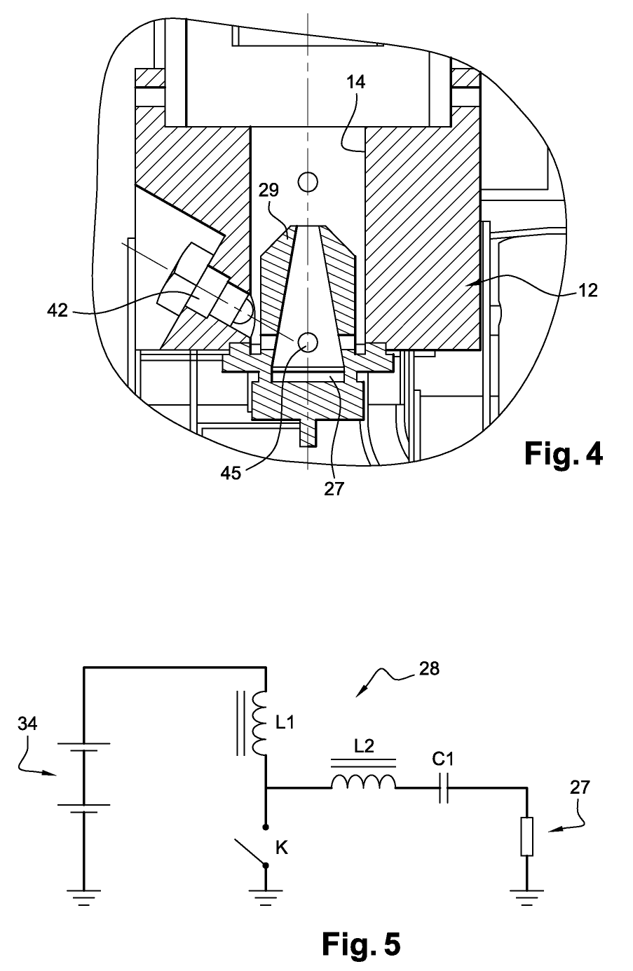

The second tank 23 is arranged upstream from the first tank 18 relative to the vessel 14 (FIG. 4), and it is connected to the first tank 18 via second means 24 for conveying liquid. The rinsing liquid can thus be used to rinse all of the ducts through which the liquid for atomizing passes while it is being diffused.

It should be observed that the atomizer device 10 includes means 26 for shutting the second liquid-conveying means 24. Thus, the second liquid can flow into the device 10 only when the means 26 release the second liquid-conveying means, e.g. while the first tank 18 is empty.

In a variant, instead of the means for receiving the second tank 23, the atomizer device 10 could include means for connection to an external source of liquid, such as means for connection to a filtered water outlet.

The diffuser 12 includes an ultrasound emitter 27 (FIGS. 4 and 5) for emitting ultrasound waves into a jet of liquid, so as to generate a mist of fine droplets.

The ultrasound emitter 27 is usually a piezoelectric element, with vibration being imposed by vibration control means 28.

Together with the ultrasound emitter, the control means 28 form an electronic control circuit as shown in FIG. 5, in which references L1 and L2 designate coils, reference C1 designates a capacitor, and reference K designates a switch. Such a control circuit imparts vibration to the piezoelectric element 27 at a predetermined steady frequency.

It should be observed that such an electronic circuit is relatively insensitive to variations in impedance and it is protected against current and voltage surges as occur when the ultrasound emitter 27 is caused to operate with a quantity of liquid that is small.

The diffuser 12 also includes a nozzle 29 of frustoconical shape in fluid communication with the vessel 14, such that the nozzle 29 is fed by the liquid in the vessel 14. Preferably, the nozzle 29 extends in a longitudinal direction that slopes relative to a vertical direction when the device 10 is in operation so as to encourage filling thereof with the liquid that is to be atomized and so as to ensure that the ultrasound emitter 27 operates properly.

The ultrasound waves generated by the ultrasound emitter 27 create pressure in the liquid that induces a jet of liquid to be created at the outlet from the nozzle 29, where the frustoconical shape of the nozzle serves to focus the ultrasound waves on the jet of the liquid.

This liquid jet reduces the level of liquid in the nozzle 29 which is then fed with new liquid coming from the vessel 14 via a system of communicating channels, the nozzle 29 having openings 45 provided for this purpose formed through its base. Thus, once the ultrasound emitter 27 has been put into operation, the jet of liquid is fed continuously without it being necessary to use an additional pump.

The ultrasound waves focused on the jet of liquid serve to atomize the liquid into fine droplets, with the mist of fine droplets as generated in this way being exhausted via a chimney 30, in particular with the help of a fan 32.

The fan 32 (FIG. 1) also serves to cool the various elements of the device 10, and in particular the control means 28;

The chimney 30 is preferably flexible and steerable so as to make it easier to diffuse the atomized liquid in any desired direction, thus making it possible to reach surrounding zones that are difficult to access. Furthermore, the chimney 30 is preferably adjustable in height so as to adapt the height from which the atomized liquid is diffused to the surroundings.

It should be observed that such a device is suitable for diffusing the atomized liquid at a relatively high rate, i.e. about 1 liter per hour (L/h) so long as the level of water in the vessel is sufficient.

It should also be observed that the diffuser 12 requires little energy for its operation. It is thus possible to power the atomizer device 10 from a rechargeable battery 34. This provides the atomizer device 10 with a high degree of portability, and it can operate equally well in surroundings fitted with electricity power supply means and in surroundings that are not fitted with such power supply means.

For proper operation of the ultrasound emitter 27, the quantity of liquid in the vessel 14 must be maintained between a predetermined minimum and a predetermined maximum. For this purpose, means 36 are provided for controlling the operation of the ultrasound emitter and the supply of liquid to the vessel 14.

These control means 36 are connected to means 38 for monitoring the level of liquid in the vessel 14, including a high level sensor 40 and a low level sensor 42 for sensing the level of liquid in the vessel 14, respectively defining predetermined maximum and maximum levels for liquid in the vessel 14.

Preferably, the high and low level sensors 40 and 42 are optical, capacitive, or ultrasound sensors.

In a variant, the means 38 for measuring liquid level need not include the low level sensor, in which case the low level is determined by means for measuring the voltage across the ultrasound emitter 37 and the current flowing through the ultrasound emitter 37. This voltage and this current depend on the level of liquid above the ultrasound emitter 27. It is thus possible to determine the low level as a function of the voltage and current.

The control means 36 control shutter means 44 (FIG. 2), e.g. a solenoid valve 44, serving to shut or open the liquid-conveying means 20, respectively when the high level sensor 40 detects that the level of the liquid is substantially at or below its predetermined maximum. Thus, the level of liquid in the vessel 14 never exceeds the predetermined maximum.

Furthermore, the control means 36 are suitable for switching the ultrasound emitter 27 on and off, in particular for the purpose of interrupting the emission of ultrasound when the level of water reaches a predetermined stop level. Generally, the predetermined stop level is the predetermined minimum level as detected by the low level sensor 42.

The predetermined minimum level for the liquid corresponds to the minimum level of liquid in the vessel 14 necessary to enable the ultrasound emitter 27 to operate without overheating.

It should be observed that the vessel 14 is preferably shaped so as to minimize the volume of liquid when the liquid is at the predetermined minimum level. For this purpose, the distance between the nozzle 29 and the walls of the vessel 14 is the smallest possible that enables the diffuser 12 to operate properly. Grooves can also be provided in the walls of the vessel 14 or in the outside surface of the nozzle 29, thereby enabling the volume of liquid at the predetermined minimum level to be further reduced.

In accordance with the invention, the control means 26 are suitable for interrupting the ultrasound emitter 27 for an interruption duration, and for putting the ultrasound emitter 27 back into operation providing, at the end of the interruption duration, the level of liquid in the vessel is above the predetermined minimum level.

Thus, such an atomizer device is suitable for implementing an optimized liquid atomizing method as described below.

When the appliance is put into operation, the nozzle 29 is fed with liquid as described above. When the high level sensor 40 (FIG. 2) detects that the level of liquid is sufficient for proper operation of the ultrasound emitter 27, the emitter is put into operation.

This leads to a stage during which the liquid is atomized and during which the liquid is diffused into the surroundings as described above.

During this stage, the solenoid valve 44 successively shuts and opens the liquid-conveying means 20 so that the level of liquid in the vessel 14 remains substantially at the maximum level.

When the liquid tank 18 is empty, the level of liquid in the vessel 14 decreases, with the valve 44 remaining in its position for opening the liquid-conveying means 20. The atomization stage continues until the liquid reaches the predetermined stop level, i.e. generally until the low level sensor 42 detects that the level of liquid in the vessel is substantially at the predetermined minimum level.

This leads to a temporary stage of the ultrasound emitter 27 being interrupted for an interruption duration.

It should be observed that the reaction times of the low level sensor 42 and of the control means 36 need to very short (of millisecond order) in order to interrupt the ultrasound emitter 27 as soon as possible after the level of liquid has reached the predetermined minimum level, so as to prevent the emitter being damaged by overheating.

The duration of the interruption enables the liquid contained in the nozzle 29, i.e. the liquid that was being atomized, to fall back into the vessel 14, thereby raising the level of liquid in the vessel 14 which then generally moves above the predetermined minimum level. The level of liquid then becomes sufficient to enable the ultrasound emitter 27 to vibrate again without being damaged by overheating. It is then possible to perform another stage during which the liquid is atomized.

It should be observed that the duration of the interruption may be a predetermined duration, calculated in such a manner that of the liquid contained in the nozzle has had time to drop back into the vessel 14 at the end of the predetermined duration. In a variant, the duration of the interruption can be determined dynamically, the duration terminating when the level of liquid in the vessel 14 again moves above the predetermined minimum level. Under such circumstances, provision can then be made for a minimum predetermined interruption duration in order to ensure that a certain quantity of liquid contained in the nozzle has indeed dropped back into the vessel at the end of the minimum interruption duration.

Thereafter, the ultrasound emitter 27 is reactivated if the level of liquid again moves above the predetermined minimum level, thus again applying pressure within the liquid and leading to a new quantity of the liquid passing into the nozzle where it is atomized, with this taking place in a manner that is safe for the ultrasound emitter 27.

The level of liquid in the vessel 14 then returns to being substantially at the predetermined minimum level, and this new stage of atomizing the liquid is terminated in the same manner as before.

It is then possible to perform a new stage of temporary interruption of the ultrasound emitter, and to repeat the stages of interruption and atomization as described above as often as necessary to ensure that, at the end of an interruption stage, the level of liquid in the vessel 14 remains substantially at or below the predetermined minimum level in spite of the fact that the liquid contained in the nozzle 29 has dropped back into the vessel 14.

Under such circumstances, it is considered that there no longer remains enough liquid to enable the ultrasound emitter 27 to operate without overheating, and operation moves onto a stage in which the ultrasound emitter 27 is stopped, thereby terminating atomization of the liquid into the surroundings.

When the predetermined duration is determined dynamically as a function of liquid level, operation of the ultrasound emitter 27 passes to the stop stage once the duration of an interruption exceeds a predetermined duration, e.g. about ten seconds. It is considered that about ten seconds suffices for all of the liquid contained in the nozzle 29 to drop back into the vessel 14. Thus, if the level of liquid continues to be substantially at or below the predetermined minimum level at the end of the ten seconds, then there no longer remains sufficient liquid to enable the ultrasound emitter 27 to operate without overheating.

Several variants can be applied to the operation of the atomizer device.

In a first variant, provision can be made to reduce the power of the ultrasound emitter 27 when the water level decreases, e.g. in proportion to the water level.

Thus, when the water level is below the predetermined maximum level and the valve 44 is in its position opening the liquid-conveying means 20, it is deduced that the liquid tank is empty and that the level of liquid in the vessel is going to decrease. The power of the ultrasound emitter 27 is then reduced so as to avoid overheating as the liquid level diminishes.

In a second variant, the predetermined stop level is the predetermined maximum level when the valve 44 is in its position for opening the liquid-conveying means 20. Thus, stages in which the operation of the ultrasound emitter 27 is interrupted temporarily can be performed as soon as the maximum level is no longer reached by the liquid while the valve 44 is in its position for releasing the liquid-conveying means 20, i.e. as soon as the liquid tank is empty.

Under such circumstances, the stages of temporarily interrupting the ultrasound emitter 27 and the atomization stages can be performed as described above for some predetermined number of times or until the water level reaches the predetermined minimum level.

Optionally, it is then possible to pass to a stage of atomizing the second liquid in order to rinse the device, this stage being performed in a manner similar to the above-described atomization.

It should be observed that the rinsing liquid, generally water, serves to dilute the remaining dead volume of liquid, which is then atomized into the surroundings together with the water.

Thus, all of the liquid contained in the first tank 18 is atomized into the surroundings, thus making it possible to determine accurately the quantity of that liquid that is atomized.

Water generally continues to be atomized until the humidity in the surroundings as measured using the humidity sensor 25 reaches a predetermined value, e.g. serving to ensure maximum effectiveness of a disinfectant that has been atomized.

In a variant, provision can be made to open the shutter means 26 while the first liquid is being atomized, in order to control humidity during atomizing or in order to dilute the first liquid while it is being atomized.

It should be observed that the stage of atomizing the second liquid is optional since it is possible to allow the dead volume of the first liquid to evaporate on its own when the dead volume is small enough.

Finally, it should be observed that the invention is not limited to the embodiment described above.

It is possible to modify the atomizer device by adding or removing certain characteristics without thereby going beyond the ambit of the invention.

For example, the atomizer device may include more than two tanks of liquid connected in parallel, in order to mix the liquids for atomizing.

The atomizer device could also include a plurality of liquid diffusers operating simultaneously in parallel, e.g. in order to diffuse the liquid for atomizing and to diffuse water for controlling humidity.

While the method herein described, and the form of apparatus for carrying this method into effect, constitute preferred embodiments of this invention, it is to be understood that the invention is not limited to this precise method and form of apparatus, and that changes may be made in either without departing from the scope of the invention, which is defined in the appended claims.

What is claimed is:

1. A method of atomizing liquid with a liquid atomizer device comprising an open-topped vessel suitable for containing a liquid for atomizing, and an atomized liquid diffuser arranged in the open-topped vessel, the diffuser being of the type comprising both a nozzle containing liquid coming from the vessel and an ultrasound emitter suitable for emitting ultrasound waves into the liquid so as to atomize it, the method comprising a stage of atomizing the liquid, which stage is continued until the level of liquid in the vessel is substantially at a predetermined stop level, wherein the method further comprises:
a stage of temporarily interrupting the ultrasound emitter for an interruption duration, which stage is performed after the atomizing stage, and during which the liquid contained in the nozzle Drops back into the vessel; and
a new atomizing stage is performed, providing the level of liquid in the vessel at the end of the interruption duration is above a predetermined minimum level.

2. The method of atomizing liquid according to claim 1, in which the predetermined stop level is the predetermined minimum level.

3. The method of atomizing liquid according to claim 1, in which the interruption duration comes to an end when the level of liquid in the vessel becomes above a predetermined minimum level.

4. The method of atomizing liquid according to claim 1, including a stage in which the ultrasound emitter is stopped, said stage following the stage of temporarily interrupting said ultrasound emitter if, at the end of the interruption duration, the liquid level in the vessel remains substantially at or below the predetermined minimum level, and/or if the duration of the interruption exceeds a predetermined duration.

5. The method of atomizing liquid according to claim 4, including a stage of rinsing the device during which a second liquid is delivered into the appliance, in particular into the vessel, said second liquid being atomized in the same manner as the previously atomized liquid.

6. The method of atomizing liquid according to claim 5, in which the second liquid is a rinsing liquid.

7. The method of atomizing liquid according to claim 6, in which the rinsing liquid is water, said water being atomized until the humidity in the surroundings into which the liquids are atomized reaches a predetermined value.

8. The method of atomizing liquid according to claim 1, including a stage of setting the ultrasound emitter into operation when the level of liquid in the vessel is substantially at a predetermined maximum level.

9. A liquid atomizer device for implementing an atomizing method according to claim 1, the device comprising an open-top vessel suitable for containing a liquid to be atomized, and an atomized liquid diffuser arranged in the vessel, the diffuser being of the type comprising both a nozzle containing the liquid coming from the vessel and an ultrasound emitter suitable for emitting ultrasound waves into the liquid so as to atomize it, wherein the device further comprises:
measurement means for measuring the level of liquid in the; and
means for interrupting the ultrasound emitter during an interruption duration and for putting the ultrasound emitter back into operation if, at the end of the interruption duration, the level of liquid in the vessel (14) is above the predetermined minimum level.

10. The liquid atomizer device according to claim 9, including means for controlling vibration of the ultrasound emitter to impose vibration on the ultrasound emitter at a predetermined steady frequency while the emitter is in operation.

11. The liquid atomizer device according to claim 9, including means for receiving a first tank of liquid to be atomized for feeding to the vessel, and means for receiving a second tank containing a second liquid to be atomized and arranged upstream from the means for receiving the first tank relative to the vessel.

12. The liquid atomizer device according to claim 9 in which the nozzle is frustoconical in shape and extends in a longitudinal direction that is inclined relative to a direction that is vertical when the device is in operation so as to encourage filling of the nozzle by the liquid for atomizing and so as to ensure that the ultrasound emitter operates properly.

13. The liquid atomizer device according to claim 9, in which the means for measuring the level of liquid in the vessel comprise a high level sensor and a low level sensor for sensing the level of the liquid, the low level sensor defining the predetermined minimum level.

14. The liquid atomizer device according to claim 13, in which the low level sensor is arranged in the vessel in such a manner that the predetermined minimum level is substantially the minimum level of liquid at which the ultrasound emitter can operate without overheating.

15. The liquid atomizer device according to claim 1, including a sensor for sensing the humidity in surroundings into which the liquid is atomized.

16. The liquid atomizer device according to claim 1, in which the vessel is shaped to minimize the volume of liquid when the liquid is at the predetermined minimum level.

17. A liquid atomizer device having:
a vessel suitable for containing a liquid for atomizing and an atomized liquid diffuser arranged in the vessel, the diffuser comprising both a nozzle containing liquid coming from the vessel and an ultrasound emitter suitable for emitting ultrasound waves into the liquid so as to atomize it;
said liquid atomizer device comprising:
a control coupled to said ultrasound emitter for controlling said ultrasound emitter such that said liquid is atomized until a level of liquid in the vessel is substantially at a predetermined stop level;
said control temporarily interrupting said ultrasound emitter for an interruption duration after atomizing of said liquid and during which said liquid contained in said nozzle drops back into the vessel; and
said control further energizing said ultrasound emitter to again atomize said liquid if a level of liquid in the vessel at the end of said interruption duration is above a predetermined minimum level.

18. The liquid atomizer device according to claim 17, in which the predetermined stop level is the predetermined minimum level.

19. The liquid atomizer device according to claim 17, in which the interruption duration comes to an end when the level of liquid in the vessel becomes above a predetermined minimum level.

20. The liquid atomizer device according to claim 17, wherein said control stops said ultrasound emitter after said control temporarily interrupts said ultrasound emitter if, at the end of the interruption duration, said liquid level in the vessel remains substantially at or below the predetermined minimum level, and/or if the duration of the interruption exceeds a predetermined duration.

21. The liquid atomizer device according to claim 17, wherein said device comprises a second vessel containing a second liquid and a valve for controlling release of said second fluid, said valve causing said second fluid to be released so that it can be atomized after atomizing of said liquid.

22. The liquid atomizer device according to claim 21, in which the second liquid is a rinsing liquid.

23. The liquid atomizer device according to claim 22, in which the rinsing liquid is water, said water being atomized until the humidity in the surroundings into which the liquids are atomized reaches a predetermined value.

24. The liquid atomizer device according to claim 1, wherein said ultrasound emitter is energized by said control when a level of liquid in said vessel is substantially at a predetermined maximum level.
